(19) United States
(12) Patent Application Publication
(10) Pub. No.: US 2004/0227349 A1
(43) Pub. Date: Nov. 18, 2004

(54) Multi-point lock assembly

(76) Inventor: Andre Denys, Sterling Heights, MI (US)

Correspondence Address: Thomas N. Young, Young & Basile, P.C., Suite 624, 3001 West Big Beaver Road, Troy, MI, 48084, US

(21) Appl. No.: 10/436,660

(22) Filed: May 13, 2003

(51) Int. Cl. E05C 7/00

(52) U.S. Cl. 292/26

(57) ABSTRACT

A multi-point latch assembly having a locking unit operably positioned in a closure member such as a door or window. The latch unit has a pair of latches with slots formed therein permitting the latches to simultaneously slide and pivotally engage a stationary pin. A keeper unit is operably positioned in a stationary member such as a door jam in a wall or a window sash. The keeper unit has a pair of pivotally movable hooks for selectively engaging the pair of latches in the latch unit. The latch unit has an actuator unit located internal to the latch unit for causing the hooks and latches to engage one another. The closure member is prevented from moving relative to the stationary member without first disengaging the hooks and latches from one another. The multi-point latch assembly has a stop rod located in the keeper unit. A release button located on the latch unit engages the stop rod when the closure member is closed. The latch unit is incapable of actuating the hooks and latches until the release button contacts the stop rod when the closure member is in a closed position relative to the stationary member.

### FIELD OF THE INVENTION

The present invention relates to a multi-point lock assembly having locking hooks positioned in the stationary keeper of a door unit.

### BACKGROUND OF THE INVENTION

In a typical sliding door installation, a lock unit having one or more hooked locking members is mounted into a movable door. A keeper unit is mounted into a stationary door opening member or jamb. The door is closed by bringing the lead edge into contact with the jamb and then locked by rotating a thumb turn to cause the locking hooks to extend out from the edge of the door and into the slots in the keeper plate.

A problem associated with this conventional configuration is that because the thumb turn can be operated in any door position, the hooks can be extended prior to the door being closed. If the door is forcibly closed with the hooks extended, damage can be caused to the hooks, to the keeper plate, or to both.

One way to solve this problem is to use hooks which collapse when slammed against the stationary keeper plate. This method of preventing damage to the lock mechanism is more expensive due to the complexity of the design.

### SUMMARY OF THE INVENTION

The present invention provides a multi-point lock assembly for sliding closures, such as patio doors, which eliminates the problems associated with the prior art devices as described above.

In general, this is accomplished in an assembly comprising a latch unit which is placed in the sliding closure and a keeper assembly which is placed on the stationary closure frame, typically called a jamb. In accordance with the invention, the keeper is provided with hooks which normally occupy a retracted position but which are rotated to a partially set position by bringing the leading edge of the closure near or into contact with the keeper unit. In the partially set position, the hooks extend into the latch unit, but do not provide a fully activated closure-to-jamb lock until a mechanism on the latch unit, typically a thumb turn or a key, is rotated to activate latches within the latch unit to complete the rotation of the hooks and fully lock the closure to the joint.

The invention can be used with any kind of sliding closure including both patio doors and sliding windows or closure panels.

In an illustrative embodiment of the invention, the multi-point latch assembly has a stop rod located in the keeper unit. A release button located on the latch unit engages the stop rod when the closure member is closed. The hooks and latches are incapable of being actuated until the release button is depressed by the stop rod. The release button is contacted and depressed by the stop rod when the closure member is in a closed position relative to the stationary member.

The hooks include a substantially J-shaped hook portion extending from a pivot center of rotation. The J-shaped hook portion engages a corresponding latch when the latch unit and keeper unit are locked to one another. The hook also includes a tab extending from a center of rotation at an oblique angle relative to the hook portion. An adjustable screw located in the latch unit engages the tab of each hook when the closure member closes. The adjustable screw causes the hook to rotate at a discreet angle out of the keeper unit and into the latch unit.

An actuator for actuating the latch mechanism is located in the latch unit. A pair of upper and lower channel bars, having first and second ends are connected to the actuator at the first ends thereof. The channel bars have an offset extension at the second ends thereof. The offset extension has an aperture for a pivot pin to engage with and extend between each pair of channel bars. The pivot pin pivotally connects with a corresponding latch positioned between the offset extensions. The channel bars include at least one rod extending between an inline portion of each pair of channel bars. The rod engages a corresponding hook that has rotated into the latch unit when the moveable member is closed. The rod then moves the hook into a locked position with the corresponding latches.

In one embodiment of the invention, an adjustable clip is operably associated with each keeper unit for positioning the hooks at a predetermined location relative to the latch unit. Each adjustable clip has two sides and a mounting member extending there between for connecting the clips to a keeper plate.

In an alternate embodiment of the invention, a U-shaped channel keeper is positionably adjustable by attaching a shim to the backside of the U-shaped channel keeper prior to attaching the keeper to the stationary member. A plurality of plastic filler pieces snap in the U-shaped channel keeper adjacent the hooks for providing a flush surface at the edge of the U-shaped channel.

In operation, the multi-point lock requires the closure member to be shut before the hooks can extend outwardly from the keeper during the locking sequence. As the closure member closes, the moveable member engages a tab on each hook causing the hook to rotate outwardly away from the keeper unit. The lock actuator is actuated by turning a key or a thumb turn. The actuator rotates the corresponding latches and the hooks until each are engaged with one another. The tension between the latches and hooks is automatically adjusted via biasing means integral to the actuator system.

An anti-slam feature for the multi-point lock assembly is provided for preventing the hooks and latches from rotating into the locking position when the latch unit, located on the moveable member, is displaced from an engaged position relative to the keeper-unit which is located in the stationary member. A release button, located in the latch unit, is engaged by a stop-rod, located in the keeper-unit, when the moveable member engages the stationary member during closing. Once the release button is depressed, the actuator can be be turned and the lock mechanism is free to complete the locking sequence.

A method for assembling a multi-point lock assembly includes adjusting rollers for aligning the moveable member with the stationary member. Once the moveable member is aligned, at least one pointed head screw is threaded into a trim plate located on the outer edge of the latch unit. The moveable member is then closed a sufficient distance for the pointed head screw to mark the stationary member. The keeper unit is then installed at the marked location so that perfect alignment with the latch unit is achieved. The pointed head screw is then reversed and threaded completely into the trim plate.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a view of a multi-point lock assembly including a latch unit positioned in a sliding door and a keeper unit positioned in a stationary jam;

FIG. 2a is a side view of a latch unit with latches in an unlocked position;

FIG. 2b is side view of the latch unit with latches in a locked position;

FIG. 2c is an enlarged view of the actuator unit shown in FIGS. 2b and 2c.

FIG. 3 is an exploded view of the latch unit;

FIG. 3a is an enlarged exploded view of the actuator unit of FIG. 3;

FIG. 3b is a perspective view of an actuator cap;

FIG. 4a is a side view of the keeper unit with the hooks in an unlocked position;

FIG. 4b is a side view of the keeper unit with the hooks in a locked position;

FIG. 5 is a side view of the latch unit and keeper-unit locked together;

FIG. 6 is a perspective view of a trim plate;

FIG. 7 is an exploded view of a keeper unit in a first embodiment;

FIG. 8 is an exploded view of a keeper unit in a second embodiment;

FIG. 9 is a perspective view of a shim;

FIG. 10 is a view of the multi-point lock assembly with keeper positioning marking screws.

### DESCRIPTION OF THE PREFERRED EMBODIMENT

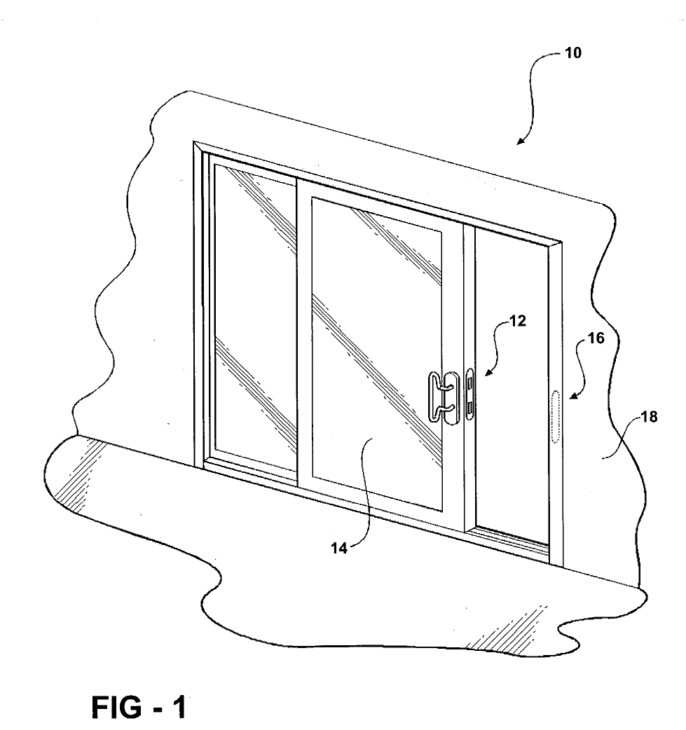

Referring now to FIG. 1, a multi-point lock assembly 10 located in a typical environment is shown therein. A latch unit 12 is operably positioned in a closure member 14. A keeper unit 16 is operably positioned in a stationary member or jamb 18. The closure member 14 is typically a sliding patio door and the stationary member 18 is typically a frame piece in the wall of building as depicted in FIG. 1. The multi-point lock assembly 10 is not limited to this particular configuration, however, because the moveable member can be a sliding window, pocket door, other similar types of apparatus.

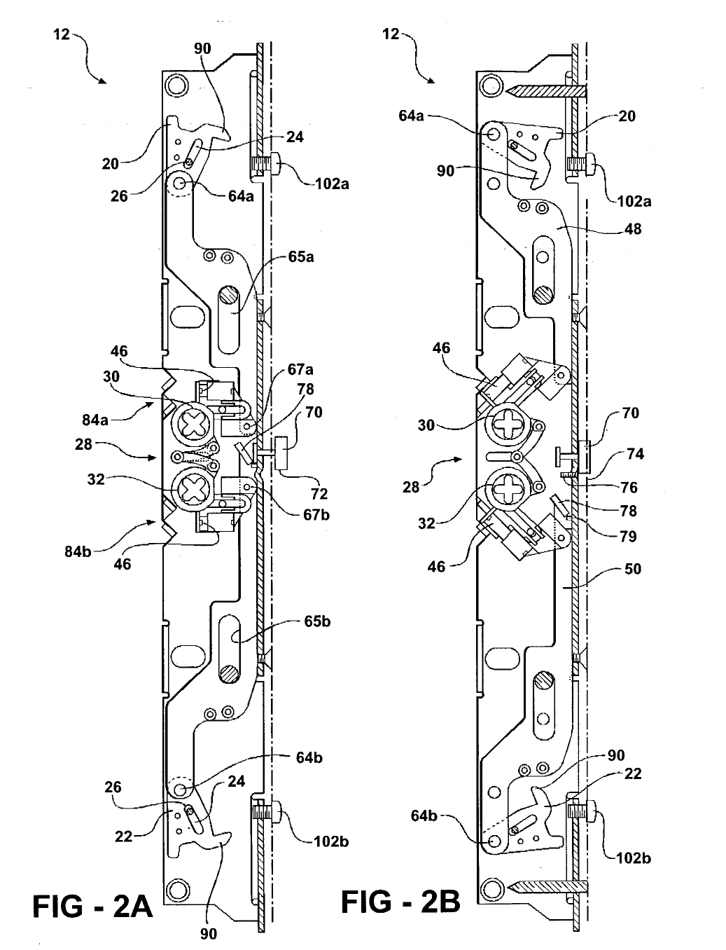

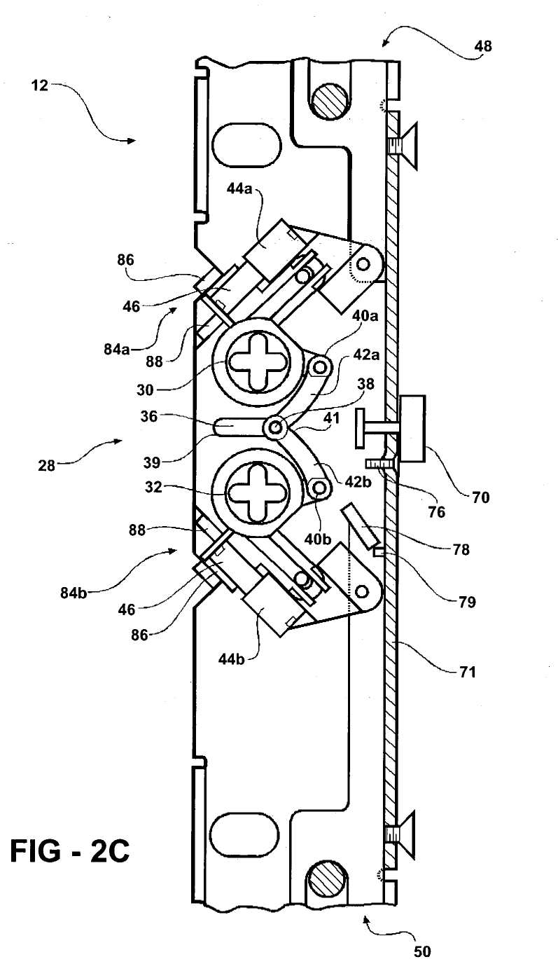

Referring now to FIGS. 2a, 2b, and 2c, a side view of the latch unit 12 is shown therein. The latch unit 12 has pair of latches 20, 22. Each latch 20, 22 has a slot 24 that simultaneously slides and pivotally engages with a stationary pin 26. An actuator unit 28 for locking the multi-point lock assembly 10 is actuated by a key or a thumb-turn (not shown). The actuator unit 28 (best seen in FIGS. 2c and 3a) includes two gears 30 and 32 that are rotationally coupled to one another such that when either gear 30 or 32 is rotationally actuated, the opposing gear 30 or 32 will also rotate at the same angular velocity, but in the opposite direction. The coupling mechanism includes a slot 36 positioned between the two gears 30, 32 such that a sliding pin member 38 can slide from one end 39 of the slot 36 to the other 41 when the gears 30, 32 are rotatingly actuated. Each gear 30, 32 has a pivotal mount 40a, 40b attached to a connecting member 42a, 42b, respectively. The connecting members 42a, 42b are pivotally attached to the pivotal mounts 40a, 40b on the gears 30, 32 at a first end and pivotally attached to the sliding pin member 38 on the opposite end. For example if gear 30 is rotatingly actuated, the pivotal mount 40a rotates with the gear 30. The connecting member 42a causes the pin member 38 to translate along the slot 36. The opposing gear 32 is attached in the same manner as gear 30 with the same angular magnitude and velocity, but rotates in an opposite direction of gear 30.

The actuator units include actuator caps 44a, 44b operably connected to each gear 30, 32 such that the actuator caps 44a, 44b operate independently from one another. A spring 46 is positioned between each actuator cap 44a, 44b and their associated gears 30, 32. The springs 46 are compressed when the latch unit is in the unlocked position as shown in FIG. 2a. The springs 46 are expanded when the latch unit 12 is in a locked position as shown in FIG. 2b.

Now referring to FIG. 3, an exploded view of the latch unit 12 is shown therein. The latch unit 12 has a first set of sliding channels bars 48 for actuating the upper latch 20. The first set of sliding channel bars 48 include left 52a and right 52b channel bar. Each bar 52a, 52b of the upper set of sliding channel bars 48 includes a first end 56 for pivotally connecting with the upper latch 20. The left and right channel bars 52a, 52b of the upper channel bar set 48 each have a second end 58 for pivotally connecting with the actuator unit 28. The latch unit 12 includes a second lower set of channel bars 50 having left and right channel bars 54a and 54b. The left and right channel bars 54a, 54b of the lower set of channel bars 50 have a first end 60 for pivotally connecting with the lower latch 22. Each channel bar 54a, 54b of the lower set of channel bars 50 has a second end 62 for pivotally connecting with the actuator unit 28. The upper latch 20 is pivotally connected to a pin 64a extending between the first ends 56 of the left and right channel bars 52a, 52b of the upper set of channel bars 48. Similarly, the lower latch 22 is pivotally connected to a pin 64b extending between the first ends 60 of the left and right channel bars 54a, 54b of the lower set of channel bars 50. The upper actuator cap 44a is operably connected to the second ends 58 of the upper channel bar set 48 via pivot pin 67a. The lower actuator cap 44b of the actuator unit 28 is operably connected to the second end 62 of the lower set of sliding channel bars 50 via pivot pin 67b. A pair of side members 66a, 66b extend longitudinally along the length of the latch unit 12 for providing support for both sets of sliding channel bars 48, 50 and the actuator unit 28. The upper and lower set of sliding channel bars 48, 50 are positioned between the side members 66a, 66b for holding the latch unit assembly together with a plurality of fasteners 68 extending between the side members 66a and 66b. Each fastener 68 has an internally threaded rod 68b extending through one of the side members 66b and a threaded member 68a extending from side member 66a for threadingly engaging a corresponding threaded rod 68b. A second set of stationary pins 69 include a threaded fastener 69a extending from side member 66a for engaging a corresponding internally threaded rod 69b extending through side member 66b. A stationary pin 69 engages an elongated groove 65a, 65b located in the left 52a, 54a and right 52b, 54b channel bars of both the upper and lower sets 48, 50 of sliding channel bars, respectively. The elongated grooves 65a, 65b slidingly engage with the stationary pins 69 as the upper and lower sets 48, 50 of sliding channel bars are reciprocated back and forth during the locking and unlocking sequence of the latch unit 12.

Referring again to FIGS. 2a, 2b, and 2c the latch unit 12 has a release button 70 that is slidingly moveable between a first position 72 (shown in FIG. 2a) and a second position 74 (shown in FIG. 2b). In the first position 72, the release button is extended outward towards the keeper unit 16. The release button 70 is normally biased via actuator caps 44a, 44b in the first position 72 when the moveable member 14 is apart from the stationary member 18. The release button 70 is forced towards the latch unit 12 when the moveable member 14 is closed. A detailed description of this procedure is hereinafter provided.

The latch unit 12 has a threaded member 76 extending from a forward edge 71 of the latch unit 12 towards the actuator unit 28. A ramp 78 having a nodule 79 with a substantially horizontal surface at the lower end thereof is connected proximate the second ends 62 of the lower set of channel bars 50. The ramp 78 is angled from the nodule 79 back towards the actuator unit 28. The nodule 79 rests adjacent the threaded member 76 and is prevented from moving past the threaded member 76 when the release button 70 is in the first position 72 as shown in FIG. 2a. The threaded member 76 prevents the sliding channel bars 48, 50 from moving when the nodule 79 is in contact with the threaded member 76.

Referring to FIGS. 3a and 3b, an enlarged view of the actuator unit 28 is shown in exploded detail. The actuator caps 44a, 44b include a spring housing 202 for engaging one end of the spring 46 internally therein. The gears 30, 32 include a lower spring housing 204 for engaging the opposite end of the spring 46. The actuator caps 44a and 44b are connected with a pin (not shown) extending through apertures 206a of channel bar 52a, through aperture 208 in the actuator cap 44a, and through the aperture 206b of the channel bar 52b. Similarly, the lower actuator cap 44b is operably connected through the lower set of channel bars 54a and 54b with a pin (not shown). The pin extends through aperture 210a of the channel bar 54a through an aperture 212 in the lower actuator cap 44b and through an aperture 210b of channel bar 54b. A substantially U-shaped guide 214 integrally extends from each gear 30, 32. Each actuator cap 44a, 44b include a pair of ears 216a, 216b that slidingly engage with a substantially U-shaped slot 220 in the U-shaped guide 214. The ears 216a, 216b of each actuator cap 44a, 44b are snapped into the corresponding U-shaped slots 220 of the U-shaped guides 214 such that the actuator caps 44a, 44b will not disengage from the U-shaped slots 220 without forcibly spreading the ears 216a, 216b apart from one another. The U-shaped guide 214 slides through a slot 222 formed in the actuator caps 44a, 44b. When the latch unit 12 is in the unlocked position, the actuator caps 44a, 44b are spaced relatively close to the gears 30, 32 and the springs 46 are in a compressed state. The U-shaped guides 214 extend completely through the slot 222 and out the top of the actuator caps 44a, 44b in the unlocked position. When the latch unit 12 is in the locked position, the actuator caps 44a, 44b are spaced farther apart from the gears 30, 32, and the springs 46 expand to maximize the travel of the channel bars 48, 50.

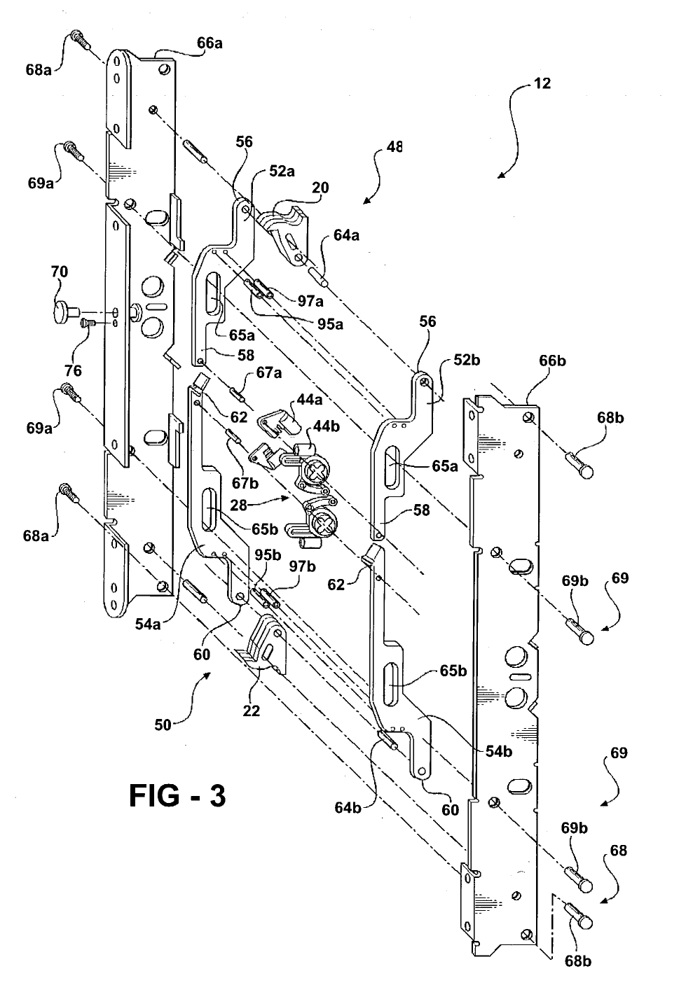

Referring now to FIGS. 4a and 4b, a stop rod 80 is located in the keeper unit 16. The latching unit 12 is restricted from movement until the stop rod 80 contacts the release button 70 when the moveable member is closed. When the moveable member 14 is closed, the stop rod 80, shown in FIGS. 4a and 4b, contacts the release button 70 and forces the release button 70 into the second position 74 adjacent the front edge 71 of the latch unit 12 (best seen in FIG. 2b). The release button 70 forces the ramp 78 towards the actuator unit 28 far enough to slip past the threaded member 76. The ramp 78 and associated nodule 79 can be moved towards the actuator unit 28 because the upper and lower sets of sliding channel bars 48, 50 are operably connected to the actuator caps 44a, 44b which provide the required play in the assembly. Once the ramp 78 is pushed inward towards the actuator unit 28, the nodule 79 can slide past the threaded member 76, thus permitting the locking unit 12 to continue the locking sequence. The locking unit 12 is restricted from movement until the stop rod 80 contacts the release button 70 when the moveable member is in the closed position. The stop rod 80 includes a tip 82 made of resilient material for easing the impact load of the moveable member 14 when the latch unit 12 of the moveable member 14 contacts the stationary keeper unit 16.

During the unlocking sequence the upper and lower sets of sliding channel bars 48, 50 are actuated such that each set 48, 50 reciprocatingly move in the opposite direction relative to the locking sequence. The ramp 78 is angled to permit the ramp 78 to slide past the threaded member 76 until the nodule 79 is reset adjacent the threaded member 76. The hooks 92, 94 and latches 20, 22 are disengaged prior to the nodule 79 being reset after which the moveable member 14 can then be displaced from the stationary member 18. The release button is biased in the second position 74 due to the actuator caps 44a, 44b acting though the channel bar set 50 causing the ramp to forcibly move the release button 70. The latch unit 12 can not be actuated again until the moveable member 14 is closed.

Referring back to FIGS. 2a, 2b, and 2c, a pair of actuator cradles 84a, 84b are included for supporting each actuator cap 44a, 44b as the actuator caps 44a, 44b rotate into position during the locking sequence. The actuator cradles 84a, 84b include two orthogonally positioned ribs 86, 88 for contacting an end and a side of each actuator cap 44a, 44b. The distal ends of the actuator caps 44a, 44b extend away from the actuator cradles 84a, 84b as the actuator caps 44a, 44b force the channel bar sets 48, 50 outward during the locking sequence.

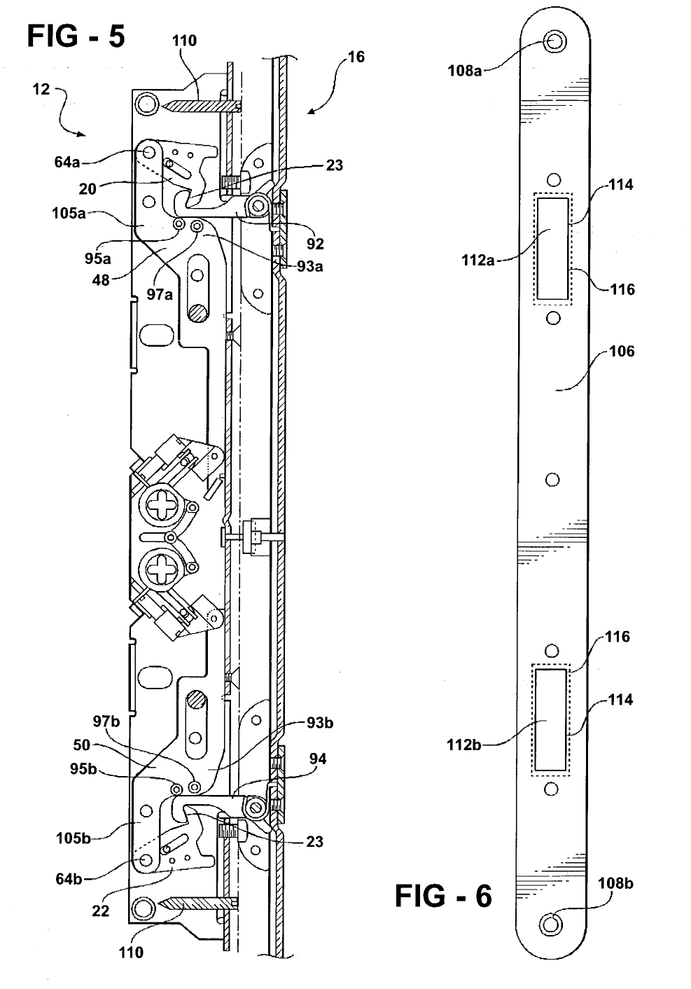

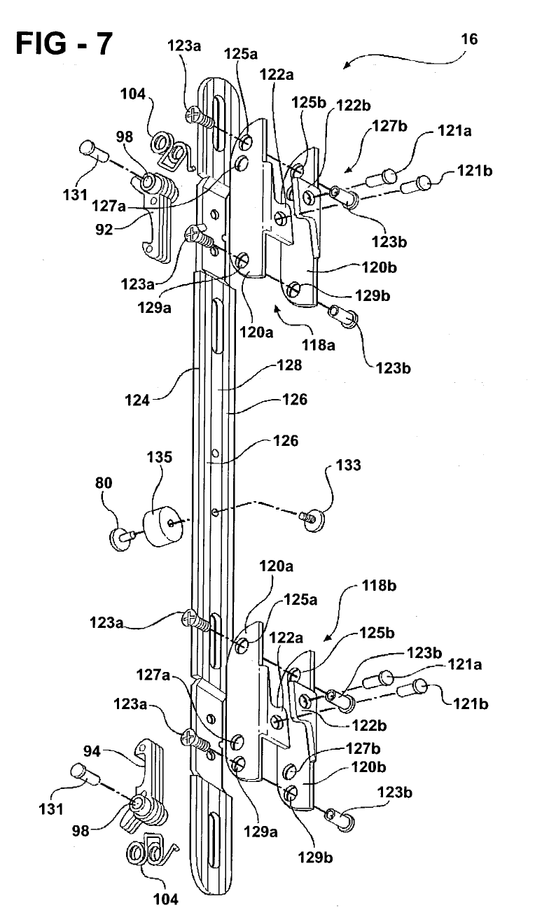

The latches 20, 22 include substantially L-shaped extensions 90 for engaging corresponding hooks 92 and 94 that are rotated into the latch unit 12 from the keeper unit 16. The hooks 92, 94 have a substantially J-shaped portion 96, as shown in FIGS. 4a, and 4b. The J-shaped portion 96 extends from a pivot center 98 of rotation. The J-shaped portion 96 engages the L-shaped extensions 90 of the corresponding latches 20, 22 when the latch unit 12 and the keeper unit 16 are locked to one another. A tab 100 on each hook 92, 94 extends from the center rotation 98 at an oblique angle relative to each hook portion 96. Adjustable screws 102a, 102b shown in FIGS. 2a and 2b are located on the latch unit 12 for engaging the tabs 100 of each hook 92, 94 and rotating the hooks 92, 94 at a discrete angle into the latch unit 12 when the moveable member 14 closes relative to the stationary member 18. Each hook 92, 94 includes biasing means 104 (best seen in FIGS. 7 and 8) for rotating each hook 92, 94 away from each corresponding latch 20, 22 when the latch unit 12 is unlocked. The biasing means 104 can be a torsional spring wrapped around the pivotal center 98 of each hook 92, 94. The torsional spring is connected to the hooks 92, 94 and to the keeper unit 16.

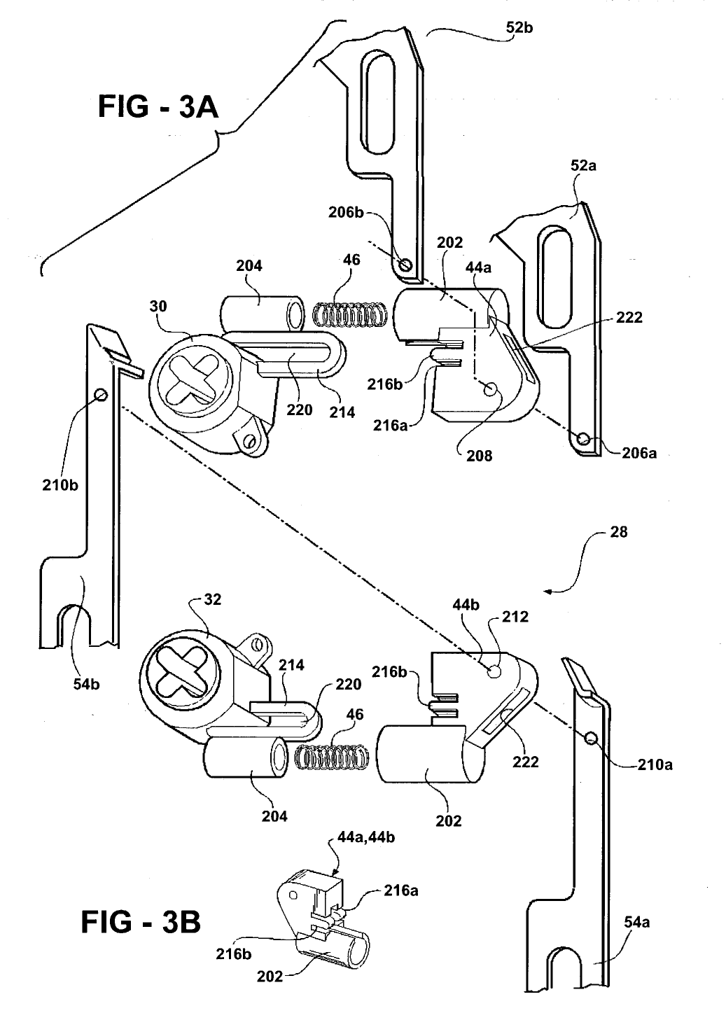

Referring now to FIG. 5, a side view of the latch unit 12 and the keeper unit 16 is shown in a locked position. The latches 20, 22 are engaged with the hooks 92, 94 along engaging surfaces 23. The upper and lower sets 48, 50 of the sliding channel bars have offset extensions 105a, 105b integral with inline end portions 93a, 93b, respectively. The inline end portions 93a, 93b of the upper and lower channel bars 48, 50 include two pins 95a, 97a extending between the left and right upper channel bars 52a, 52b. A pair of lower pins 95b, 97b extend between the lower set of sliding channel bars 50 between the left and right lower channel bars 54a, 54b. The upper set of pins 95a, 97a contact the back side of the hook 92 and continues to rotate the hook 92 until the hook 92 is engaged with the latch 20. At the same time the hook 92 is rotating into locking position, the corresponding latch 20 being pivotally connected to the offset extension 105a, through pivot pin 64a is also being rotated into locking position with the upper channel bar set 48. Simultaneously, the lower set of pins 95b, 97b contact the back side of the hook 94 and continues to rotate the hook 94 until the hook 94 is engaged with the latch 22. At the same time the hook 94 is rotating into locking position, the corresponding latch 22 being pivotally connected to the offset extension 105b, through pivot pin 64b is also being rotated into locking position with the lower channel bar set 50.

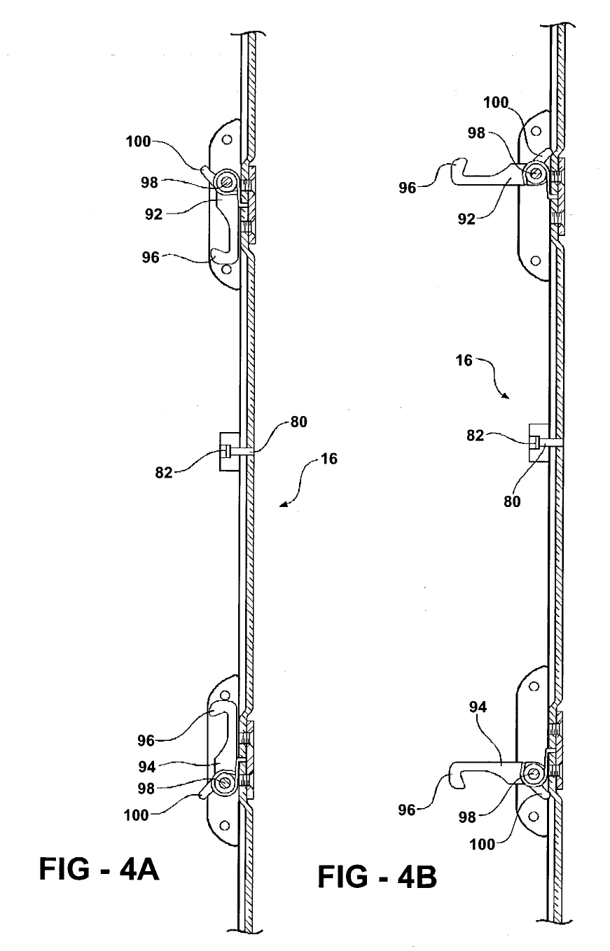

Referring now to FIG. 6, a trim plate 106 is connectible to the latch unit 12 for covering the forward front edge 71 thereof. The trim plate 106 includes tapped apertures 108a, 108b that are threadingly engagable with pointed head marking screws 110 (shown in FIG. 5). The trim plate 106 is fixedly held to the latch unit 12 by a plurality of fasteners (not shown) in addition to the pair of marking screws 110. The trim plate 106 includes through bores 112a, 112b for each hook 92, 94 to extend through as the hooks 92, 94 rotate into the latch unit 12 from the keeper unit 16. Each bore 112a, 112b has a bevel 114 formed on a perimeter edge 116 of the side facing the latch unit 12. The beveled edge 114 is operable for preventing the hooks 92, 94 from catching on the back side perimeter edge 116 and jamming therein when the latch assembly 10 moves through the unlocking sequence. The trim plate 106 shown in FIG. 6 is only one example of the various trim plate designs contemplated by the present invention. The trim plate 106 can include flat or pocket designs to coordinate with a variety of back sets.

Referring now to FIG. 7, a first embodiment of the keeper unit 16 is shown therein. Adjustable clips 118a, 118b are operably associated with each hook 92, 94 for positioning the hooks 92, 94 at a predetermined location such that the hooks 92, 94 will engage the latch unit 12 at the correct spacial position relative to the keeper unit 16 when the moveable member 14 is in the closed position. Each adjustable clip 118a, 118b has two sides 120a, 120b with a mounting member 122a, 122b extending therebetween for connecting the adjustable clips 118a, 118b to a keeper plate 124 via fasteners 121a, 121b. The keeper plate 124 has a plurality of longitudinally extended ribs 126 for increasing the strength of the keeper plate 124 and for forming a counter-bore area 128 for the heads of the threaded fasteners (not shown) to lie therein for connecting the keeper plate to the stationary member 18.

Each adjustable clip 118a, 118b includes an upper pair of apertures 125a, 125b and a lower pair of apertures 129a, 129b extending through the sides 120a and 120b respectively. Threaded fasteners 123a extend through apertures 125a and 129a located in the side 120a for threadably engaging with internally threaded posts 123b entering through apertures 125b and 129b located in the side 120b of the adjustable clips 118a, 118b. The threaded fasteners 123a and posts 123b prevent sides 120a, 120b of the adjustable clips from inadvertently spreading too far apart from one another. The hooks 92, 94 are connected through a pivot center 98 with a pivot pin 131 extending through an apertures 127a and 127b formed in the sides 120a, 120b respectively of each clip 118a, 118b. Torsional springs 104 are operably associated with the hooks 92, 94 to ensure each hook rotates out of the latch unit 12 when the closure member 14 is opened.

The stop rod 80 is fixedly held in place with a threaded fastener 133 extending through the keeper plate 124 and a cushioned bumper 135 prior to threadably engaging the stop rod 80. The cushioned bumper 135 ensures that the release button 70 of the latch unit 12 is not damaged if the closure member 14 is slammed shut.

Referring now to FIG. 8, a second embodiment of the keeper unit 16 is shown therein. A substantially U-shaped channel keeper 134 having a pivot pin 135 for attaching each hook 92, 94 within the U-shaped recess 136. The channel keeper 134 operable for positioning the hooks 92, 94 at a predetermined location relative to the latch unit 12. The channel keeper 134 has a plurality of apertures 138 for fastening members (not shown) to engage therethrough and fasten the channel keeper 134 to the stationary member 18. A plurality of substantially U-shaped filler members 140 are positioned in the U-shaped channel keeper 134 for covering the U-shaped recess 136 adjacent to the hooks 92, 94. At least one protruding element 142 extends from each side of each U-shaped filler member 140 for releasibly snap-locking with apertures 144 formed in the U-shaped channel keeper 134. The U-shaped channel keeper 134 is typically made of a metal material and the filler members 140 are typically made of a plastic, however, suitable substitute materials for each are contemplated by the present invention. The filler members 140 include a longer member 146 positioned between the hooks 92, 94. The longer filler member 146 has a thicker portion 148 to coincide with the positioning of the stop rod 80. A threaded fastener 133 engages through an aperture located in the thicker portion 148 of the filler member 146 and a cushioned bumper 135 before threadably connecting the stop rod 80 to the U-shaped channel member 134.

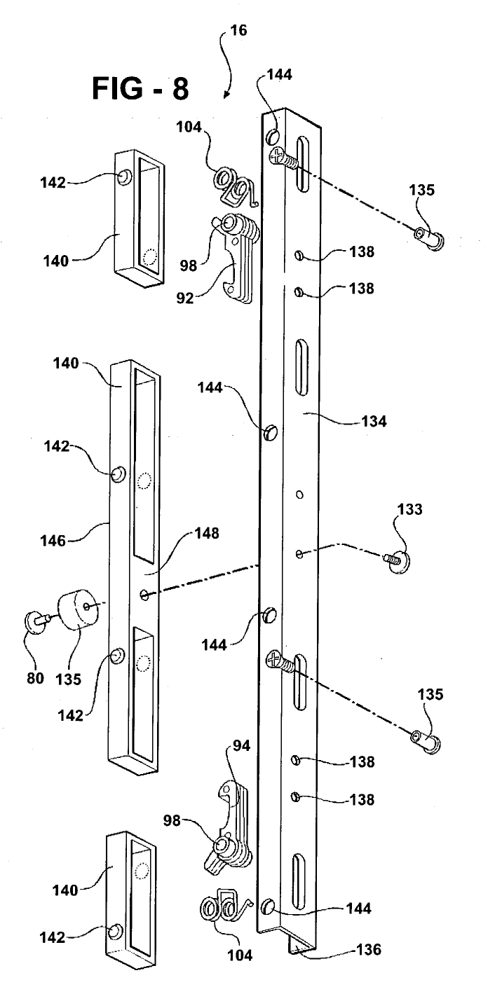

Referring now to FIG. 9, a shim 150 can be installed between the keeper unit 16 and a wall jamb of the stationary member 18. The shim 150 is used for correctly positioning the keeper unit 16 such that the hooks 92, 94 are engagable with the latches 20, 22. A plurality of elongated apertures 151 are formed in the shim 150 for allowing threaded fasteners (not shown) from the keeper unit 16 to pass therethrough and attach to the stationary member 18. The shim 150 can be pre-installed on the back side of the keeper unit 16 for ease of installation or installed straight into the jamb as desired.

In operation, the multi-point latch assembly 10, requires the moveable member 14 to be shut relative to the stationary member 18 before the locking sequence can be initiated. When the closure member 14 closes, the adjustable screws 102a, 102b located on the latch unit 12, engage the tabs 100 of each hook 92, 94. The hooks 92, 94 are rotated out of the keeper-unit 16 and into the latch unit 12 when the moveable member 14 is fully closed.

A latch actuator 28 can be actuated after the moveable member 14 is closed. The actuator unit rotates the latches 20, 22 and the corresponding hooks 92, 94 until each engage with one another. The actuator unit 28 automatically adjusts the tension between the hook 92, 94 and the latches 20, 22 via biasing means 44a, 44b. The engaged surfaces of the latches 20, 22 and the hooks 92, 94 are angled relative to a vertical axis to prevent sliding disengagement caused by an attempted forced entry. While angles greater than zero degrees have been found effective to remain securely engaged with one another, a twelve degree angle on each surface is most preferred. The combination of the angled surfaces and the biasing means 44a, 44b advantageously cooperate to prevent forced entry into a locked area.

A method for preventing the impact of extended hooks 92, 94 with the moveable member 14 is contemplated by the present invention. The anti-slam feature prevents the hooks 92, 94 and latches 20, 22 from rotating into a locking position when the latch unit 12 is displaced from an engaged position relative to the keeper-unit 16. The hooks 92, 94 and latches 20, 22 can be moved into a locking position only after the release button 70 located on the latch unit 12 is depressed by the stop rod 80 located on the keeper unit 16 when the moveable member 14 is closed.

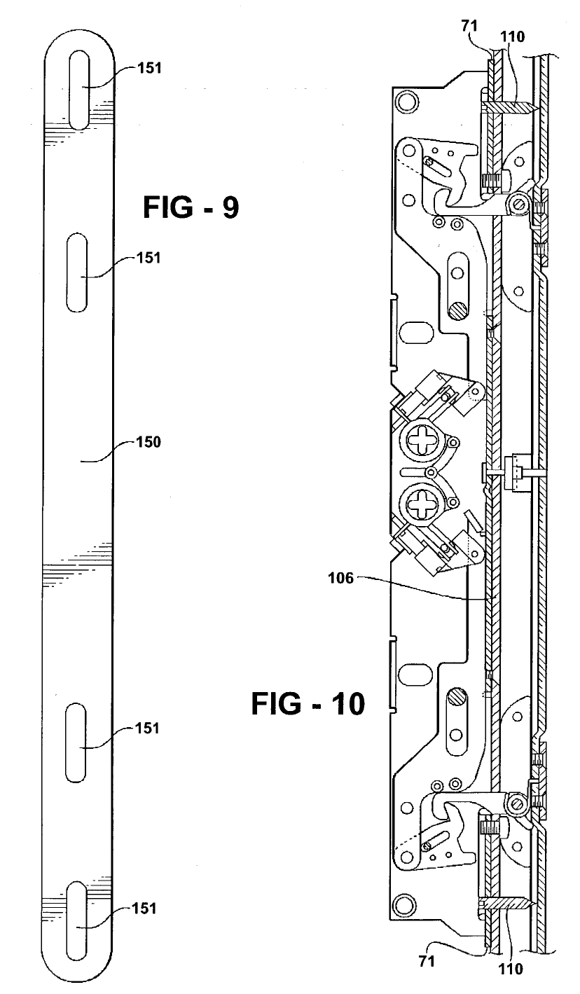

A method for assembling a multi-point latch assembly 10 is also defined by the present invention. Adjustable rollers on the moveable member 14 are adjusted such that the moveable member 14 is aligned with the stationary member 18. After installing the latch unit 12 into the moveable member 14, at least one screw 110, having a pointed head is threadingly engaged into a trim plate 106 located on the outer edge 71 of the latch unit 12 as shown in FIG. 10. The moveable member 14 is then closed a distance required to mark the stationary member 18 with the at least one pointed head screw 110. The moveable member 14 is then opened and the keeper-unit 16 is aligned with the pre-marked location and installed into the stationary member 18. The pointed head screw 110 is then reversed and threaded into the trim fit plate 106 for fastening the trim plate onto the moveable member.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A multi-point latch assembly comprising:
a latch unit mounted on the leading edge of a closure member, the latch unit having a pair of latches with slots formed therein that permit the latches to simultaneously slidingly engage and pivotally engage a stationary pin;
a keeper unit operably positioned in a stationary member to receive and abut the leading edge of the closure member, the keeper unit having a pair of pivotally moveable hooks for selectively engaging the pair of latches in the latch unit when the leading edge of the closure member abuts the keeper unit and for preventing the closure member from moving relative to the stationary member without disengaging the hooks and latches from one another; and
an actuator unit for rotating the latches and hooks into a locking position.

2. The multi-point latch assembly of claim 1, wherein the latch unit rotates the hooks into an intermediate position when the closure member is closed, the intermediate position defined by the hooks being partially rotated into the latch unit prior to the actuator unit engaging the hooks.

3. The multi-point latch assembly of claim 1, wherein the actuator unit further comprises:
upper and lower actuator gears rotationally coupled to one another such that when the upper gear rotates the lower gear rotates and vise versa;
upper and lower actuator caps operably associated with the actuator gears, each cap having first and second ends; and
biasing means in communication with each actuator gear and associated cap.

4. The multi-point latch assembly of claim 3 wherein the actuator gears further comprise:
a substantially U-shaped guide having a substantially U-shaped slot integrally extending from each gear.

5. The multi-point latch assembly of claim 4, wherein the actuator caps further comprise:
a guide slot formed through the cap for the U-shaped guide of the associated gear to engagingly extend through; and
a pair of opposing ears having projections extending inwardly on the end thereof, the ears operable for snapping into and slidingly engaging with the U-shaped groove of the U-shaped guide.

6. The multi-point latch assembly of claim 4, wherein the actuator gears and actuator caps each include housings operable for engaging a spring positioned between the gears and the caps.

7. The multi-point latch assembly of claim 3, wherein the actuator unit further comprises:
upper and lower sets of sliding channel bars, each set having left and right bars with first and second ends, the first ends connected to the upper and lower actuator caps respectively;
an offset extension at the seconds ends of each channel bar, each offset extension having an aperture for a pivot pin to extend through for pivotally connecting with a corresponding latch positioned between the extensions.

8. The multi-point latch assembly of claim 3, wherein the biasing means comprises:
a spring that is compressed in an unlocked position and expanded in the locked position.

9. The multi-point latch assembly of claim 8, wherein the actuator caps pivot about the gears and extend outward due to the force of the spring causing the channel bars to move outward during the locking sequence.

10. The multi-point latch assembly of claim 9 further comprising:
an actuator cradle for supporting each actuator cap as the actuator caps rotate into position during the locking sequence, the cradles including two orthogonally positioned ribs for contacting an end and a side of each actuator cap.

11. The multi-point latch assembly of claim 7, wherein each channel bar set further comprises:
an in-line end portion formed adjacent the offset extensions on each channel bar; and
at least one rod extending between in-line portions of the channel bars, the at least one rod contacting each hook causing the hook to pivot into locking position with the corresponding latch when the channel bars are actuated in the locking sequence.

12. The multi-point latch assembly of claim 1 further comprising:
a release button operably connected to the latch unit, the release button slidingly moveable in one of a first and second positions, the release button including biasing means for urging the button into the first position in the absence of another external force.

13. The multi-point latch assembly of claim 12 further comprising:
a threaded member extending through a front edge of the latch unit towards the actuator unit; and
a ramp formed proximate the first end of the lower set of channel bars, the ramp having a substantially flat surface nodule operable for resting adjacent the threaded member and preventing the channel bars from moving when the release button is located the first position.

14. The multi-point latch assembly of claim 12 further comprising:
a stop rod located in the keeper, the stop rod contacting the release button and forcing the release button into the second position when the moving member is in a closed position.

15. The multi-point latch assembly of claim 14 further comprising:
the hooks capable of moving into the latched position only when the release button is engaged by the stop rod.

16. The multi-point latch assembly of claim 14 further comprising:
the ramp being forced away from the threaded member when the stop rod engages the release button and forces the release button into the second position causing contact with the ramp for allowing the ramp to slide past the threaded member as the channel bars are actuated by the actuator during the locking sequence.

17. The multi-point latch assembly of claim 14, wherein the stop rod includes a cushioned bumper made of resilient material for easing the impact load on the closure member when the latch unit of the closure member contacts the stationary keeper unit.

18. The multi-point latch assembly of claim 13, wherein the ramp is angled for sliding past the threaded member during the unlocking sequence prior to resetting the nodule adjacent the threaded member.

19. The multi-point latch assembly of claim 1 wherein the latch further comprises:
a substantially L-shaped latch portion extending from pivot center of rotation of each latch for engaging the corresponding hook when the latch unit and keeper unit are locked to one another.

20. The multi-point latch assembly of claim 1, wherein each hook further comprises:
a substantially J-shaped hook portion extending from pivot center of rotation of each hook for engaging the corresponding latch when the latch unit and keeper unit are locked to one another; and
a tab extending from a center of rotation at an oblique angle relative to each hook portion.

21. The multi-point latch assembly of claim 20 further comprising:
an adjustable screw located in the latch unit for engaging the tabs of each hook and rotating the hook at a discreet angle when the moveable member closes relative to the stationary member.

22. The multi-point latch assembly of claim 1, wherein each hook further comprises:
biasing means for rotating each hook away from each corresponding latch when the latch unit is unlocked.

23. The multi-point latch assembly of claim 22, wherein the biasing means is a torsional spring wrapped around the pivotable center of each hook, the spring attached to the hook and the keeper unit.

24. The multi-point latch assembly of claim 1 further comprising:
a trim plate connectible to the latch unit for covering a front edge thereof, the trim plate having at least one tapped aperture threadingly engagable with a pointed head marking screw, the trim plate includes a through bore for each hook to extend through when entering the latch unit from the keeper unit, each bore having a bevel formed on a backside perimeter edge thereof for preventing the hooks from catching the backside edge and jamming therein when moving through the unlocking sequence.

25. The multi-point latch assembly of claim 1 further comprising:
an adjustable clip operably associated with each hook for positioning the hooks at a predetermined location matching the placement of the of the latch unit depth relative to the keeper unit when the closure member is in the closed position, each adjustable clip having two sides and a mounting member extending between the two sides for connecting the clips to a keeper plate.

26. The multi-point latch assembly of claim 25, wherein the keeper plate has a plurality of longitudinally extending ribs for increasing the strength of the plate and for forming a counterbore area for the head of threaded fasteners to lie therein.

27. The multi-point latch assembly of claim 1, wherein the keeper unit further comprises:
a substantially U-shaped channel keeper having means for attaching each hook within a substantially U-shaped recess, the channel keeper operable for positioning the hooks at a predetermined location relative to the latch unit, the channel keeper having a plurality of apertures for fastening members to engage through and fasten the channel keeper to the stationary member.

28. The multi-point latch assembly of claim 27, wherein the channel keeper further comprises:
a plurality of substantially U-shaped filler members positioned in the channel keeper for covering the U-shaped recesses adjacent the hooks.

29. The multi-point latch assembly of claim 1, wherein the filler members have at least one protruding element for releasibly snap latching with a corresponding aperture formed in the channel keeper.

30. The multi-point latch assembly of claim 1, wherein the filler members are made of a plastic material and the channel keeper is made of a metal material.

31. The multi-point latch assembly of claim 1 further comprising:
a shim installed between the keeper unit and a wall jam, the shim operable for positioning the hooks of the keeper unit relative to the latches of the of the locking unit.

32. The multi-point latch assembly of claim 1, wherein the latches and hooks each comprise an engaging surface for contacting one another in the locking position and preventing separation of the closure member from the stationary member.

33. The multi-point latch assembly of claim 32, wherein the engaging surfaces of the latches and hooks are angled relative to a vertical axis for preventing the latches and the hooks from sliding apart when a pulling load is applied to the closure member.

34. The multi-point latch assembly of claim 33 wherein the angle of each surface is substantially twelve degrees.

35. A method for locking a multi-point latch assembly comprising the steps of:
shutting a closure member relative to a stationary member;
engaging a tab on at least one hook with the closure member;
rotating the at least one hook into a latch unit located in the closure member;
initiating a locking sequence with a thumb-turn or key;
rotating a pair of corresponding latches and hooks into engagement with one another; and
mechanically adjusting the tension between the hooks and latches via biasing means.

36. The method of claim 32 further including an anti-slam feature comprising the steps of:
preventing the hooks and latches from rotating into a locking position when the closure member is displaced from an engaged position relative to the stationary member; and
rotating the locks and latches into locking position after the closure member is engaged with the stationary member.

37. A method for assembling a multi-point latch assembly comprising the steps of:
adjusting a set of rollers on a closure member for aligning the closure member with a stationary member;
inserting at least one screw having a pointed head into a trim plate located on a forward edge of the moveable member;
marking the stationary member with the pointed head screw by closing the closure member a distance required to contact the stationary member with the pointed head screw;
aligning the keeper unit with the marking on the stationary member;
installing the keeper unit at the marked location; and
reversing the screw and fastening a trim plate onto the closure member with the screw.
